(19) United States
(12) Patent Application Publication
(10) Pub. No.: US 2014/0231325 A1
(43) Pub. Date: Aug. 21, 2014

(54) Aquarium Filter

(71) Applicant: Steven Yim, La Habra, CA (US)

(72) Inventor: Steven Yim, La Habra, CA (US)

(21) Appl. No.: 13/768,896

(22) Filed: Feb. 15, 2013

(51) Int. Cl. A01K 63/04

(52) U.S. Cl. CPC A01K 63/045
USPC 210/167.23; 210/167.21

(57) ABSTRACT

A media reactor aquarium filter incorporates a simple design and allows simple media replacement. The filter includes co-axial inner and outer tubes. The outer tube includes a mounting feature and the inner tube holds the media and is removable without disturbing the outer tube. A pump at the base of the filter pumps water into the inner tube through ports at the base of the inner tube and up through the inner tube, and this through the media. The filtered water then flows though the top wall of the inner tube and down between the inner and outer tubes, and back into the aquarium. The inner tube is rotatable to vary the alignment of the ports to adjust the water flow rate through the filter.

### BACKGROUND OF THE INVENTION

The present invention relates to filters and in particular to aquarium filters.

Aquarium filters are utilized to maintain water purity in aquariums. While a variety of filters are available, they generally include flexible tubing, PVC pipe, ball valves, thumb screws, and various features creating unattractive clutter and complexity. Changing media in media filters is often messy and time consuming.

### BRIEF SUMMARY OF THE INVENTION

The present invention addresses the above and other needs by providing a media reactor aquarium filter which incorporates a simple design and allows simple media replacement. The filter includes co-axial inner and outer tubes. The outer tube includes a mounting feature and the inner tube holds the media and is removable without disturbing the outer tube. A pump at the base of the filter pumps water into the inner tube through ports at the base of the inner tube and up through the inner tube, and this through the media. The filtered water then flows though the top wall of the inner tube and down between the inner and outer tubes, and back into the aquarium. The inner tube is rotatable to vary the alignment of the ports to adjust the water flow rate through the filter.

In accordance with one aspect of the invention, there is provided an aquarium filter allowing simple replacement of filter media. Filter media is contained in an inner tube which is removable from an outer tube of the filter, with the outer tube remaining in the aquarium. The media is replaced in the inner tube, and the inner tube is inserted back into the outer tube.

In accordance with another aspect of the invention, there is provided an aquarium filter allowing simple adjustment of a water flow through the filter. Filter media is contained in an inner tube. Aquarium water is pumped by a pump into the base of the inner tube, vertically up through the media material in the inner tube, out of the inner tube into a region between the inner tube and an outer tube, back to the base of the filter, and released back into the aquarium. Ports in the base of the inner filter are adjustably alignable with ports leading to the pump. A knob at the top of the inner tube allows twisting the inner tube to adjust the alignment of the ports to control the water flow.

### BRIEF DESCRIPTION OF THE SEVERAL VIEWS OF THE DRAWING

The above and other aspects, features and advantages of the present invention will be more apparent from the following more particular description thereof, presented in conjunction with the following drawings wherein:

FIG. 1 is a side view of an aquarium filter according to the present invention.

FIG. 2 is an outer tube assembly of the aquarium filter according to the present invention.

FIG. 3 is a exploded view of an inner tube assembly of the aquarium filter according to the present invention.

FIG. 4 is an exploded view of the aquarium filter according to the present invention.

FIG. 5 is an inner tube top plug of the aquarium filter according to the present invention.

FIG. 6 is an inner tube base plug of the aquarium filter according to the present invention.

FIG. 7 is an outer tube base plug of the aquarium filter according to the present invention.

FIG. 8A is a mounting clamp of the aquarium filter according to the present invention.

FIG. 8B is a mounting platform of the aquarium filter according to the present invention.

FIG. 9 shows the aquarium filter according to the present invention mounted inside an aquarium.

FIG. 10 shows the aquarium filter according to the present invention mounted behind the aquarium.

FIG. 11 shows the aquarium filter according to the present invention mounted in a sump under the aquarium.

Corresponding reference characters indicate corresponding components throughout the several views of the drawings.

### DETAILED DESCRIPTION OF THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

A side view of an aquarium filter 10 according to the present invention is shown in FIG. 1. Filter media 11 resides inside an inner tube assembly 14 of the aquarium filter 10, and a filter pump 16 pumps aquarium water up through the filter media 11 to filter aquarium water creating filtered water.

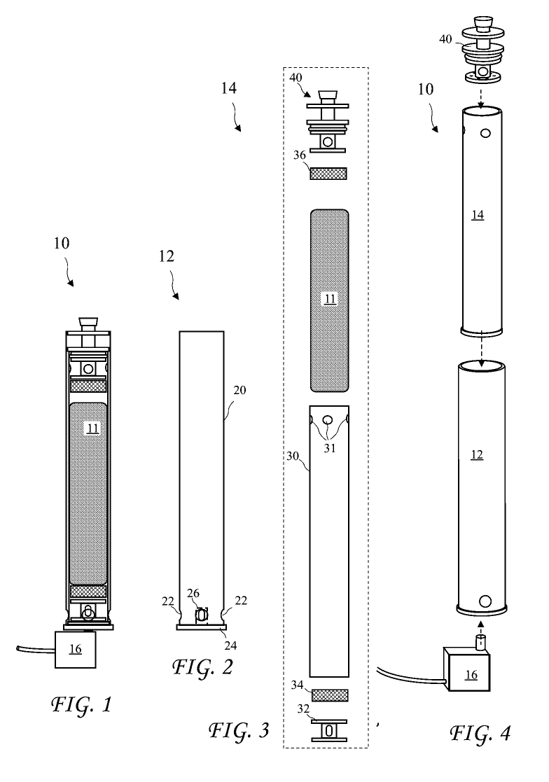

An outer tube assembly 12 of the aquarium filter 10 is shown in FIG. 2. The outer tube assembly 12 comprises an outer tube 20, an outer tube base plug 24, an outer tube entry ports 26 of the outer tube base plug 24, and filter exit ports 22 spaced apart around the base of the outer tube 20. The outer tube 20 may be any elongated tube, and is preferably a cylindrically shaped tube.

FIG. 3 is a exploded view of an inner tube assembly 14 of the aquarium filter 10. The inner tube assembly 14 includes an inner tube 30, an inner tube base plug 32 fixed to the base of the inner tube 30, a lower water permeable spacer 34 resting on the base plug 32, filter media 11, an upper water permeable spacer 36 resting on the filter media 11, and an inner tube top plug 40

FIG. 4 is an exploded view of the aquarium filter 10.

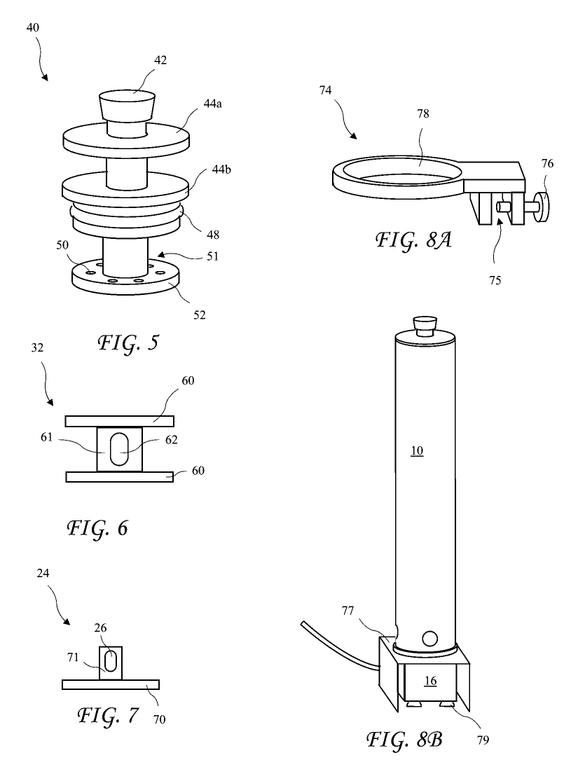

A detailed view of the inner tube top plug 40 is shown in FIG. 5. The top plug 40 includes a knob 42 for rotating the inner tube assembly 14 inside the outer tube assembly 12, first and second outer tube positioners 44a and 44b, an inner tube seal 48, and an inner tube positioner 52. The positioners 44a, 44b, and 52 center the inner tube inside the outer tube and the seal 48 restricts filtered water from escaping out of the top of the aquarium filter. Vertical ports 50 on the positioner 52 allow filtered water to pass though the positioner 52 into a transfer region 51 and through the transfer ports 31 into the outer tube 20.

FIG. 6 shows a detailed view of the inner tube base plug 32 of the aquarium filter 10. The base plug 32 includes inner tube base plug positioners 60 which center the base plug 32 in the inner tube 30. Inner tube inlet ports 62 pass through a hub 61 between the positioners 60. The base plug 32 is fixed to the inner tube 30 and rotates with the inner tube 30.

FIG. 7 shows a detailed view of the outer tube base plug 24 of the aquarium filter 10. The base plug 24 is fixed in the base of the outer tube 20 by an outer tube base plug positioner 70 which includes a spindle 71 reaching up into the outer tube 20 and the inner tube 30. The spindle 71 is hollow with an open bottom for connection to the filter pump 16 and includes outer tube inlet ports 26 between the spindle 71 interior and exterior. The inner tube base plug 32 resides over the spindle 71 and the inner tube inlet ports 62 are alignable with the inlet ports 26 allowing aquarium water pumped by the aquarium pump 16 to enter the inner tube 30. Rotating the inner tube 30, and thus the base plug 32, varies the alignment of the inlet ports 26 with the inlet ports 62 thus regulating the water flow from the filter pump 16 into the inner tube 30. The inlet ports 26 and 62 preferably have a height greater than width, and are more preferably oval shaped.

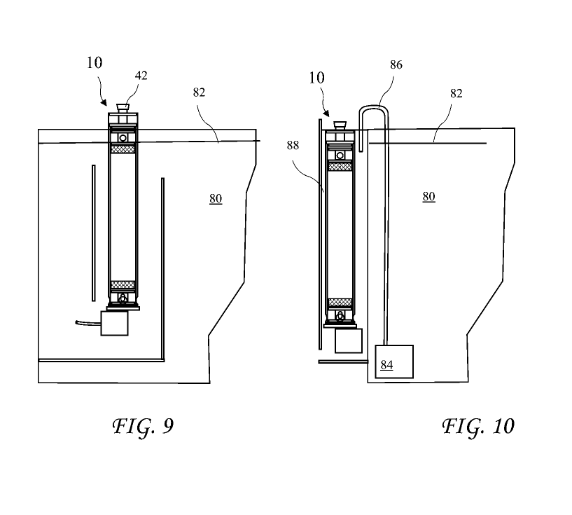

FIG. 8A shows a mounting clamp 74 of the aquarium filter 10. The mounting clamp 74 includes a loop 78 which fits over the outer tube 20, and may be an interference fit or attached using an adhesive. The mounting clamp 74 may include a slot 75 for sliding onto an edge of the aquarium and a screw 76 for tightening.

FIG. 8B shows a mounting platform 77 for the aquarium filter 10. In some instances a user may choose to locate the filter 10 away from the aquarium walls. In such instances the mounting platform 77 may be positioned within the aquarium fixed to the aquarium bottom using attachments, for example, suction cups 79 attached to the pump 16 or to the platform 77. The filter 10 is attached to the mounting platform 77 to prevent the filter 10 from rotating when the inner tube 30 is rotated to adjust the water flow.

FIG. 9 shows the aquarium filter 10 mounted inside an aquarium 18. The top of the filter 10 is above a water line 82 to allow reaching the knob 42.

FIG. 10 shows the aquarium filter 10 mounted behind the aquarium 80 in a basin 88. An aquarium pump 84 may be used to circulate aquarium water into the basin 88.

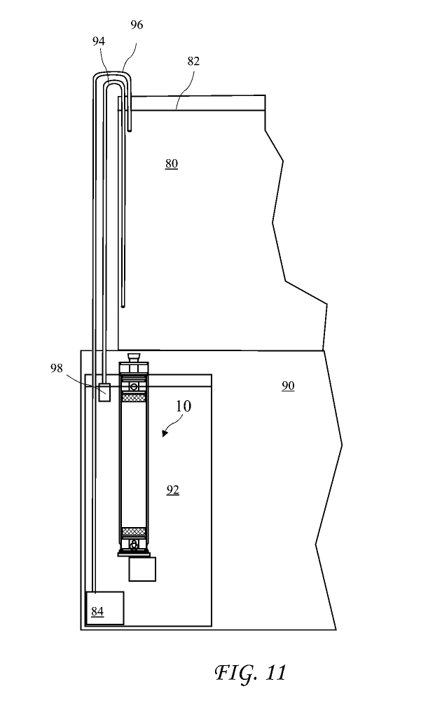

FIG. 11 shows the aquarium filter 10 mounted in a sump 92 residing in an aquarium stand 90 under the aquarium 80. Aquarium water may be released into the sump 92 through a drain tube 94 and valve 98, and pumped back into the aquarium 80 by the aquarium pump 84 through tube 96.

While the filter has been shown as including co-axial inner and outer elongated bodies comprising cylindrical tubes, a filter having square, rectangular, hexagonal, oval, or other cross-section, and filter media residing in a removable inner body and a water flow through the inner body, between the bodies, and back into an aquarium, is intended to come within the scope of the present invention.

While the invention herein disclosed has been described by means of specific embodiments and applications thereof, numerous modifications and variations could be made thereto by those skilled in the art without departing from the scope of the invention set forth in the claims.

I claim:

1. An aquarium filter comprising:
an elongated outer body;
a removable smaller elongated inner body residing inside the outer body;
a filter pump residing at a first end of the outer body in fluid communication between an aquarium and the inner body;
a filter media residing inside the inner body;
transfer ports in the inner body separated from the first end by the filter media and allowing a flow of filtered water between the inner body and the outer body; and
outlet ports in the outer body allowing the flow filtered water to be released into the aquarium

2. The filter of claim 1, wherein the filter pump resides at a bottom of the aquarium filter.

3. The filter of claim 2, further including a seal closing the top of the outer body and wherein the outlet ports are at the bottom of the outer body.

4. The filter of claim 3, further including adjustable inlet ports between the pump and the inner body allowing control of the flow of aquarium water through the filter.

5. The filter of claim 4, wherein:
the outer tube includes an outer tube base plug having outer tube inlet ports; and
the inner tube is rotatable and includes an inner tube base plug having inner tube inlet ports, the alignment of the inner tube ports with the outer tube ports adjustable by rotating the inner tube to control water flow through the aquarium filter;

6. The filter of claim 5, wherein the inner body is cylindrical shaped.

7. The filter of claim 6, wherein the outer body is cylindrical shaped.

8. The filter of claim 5, wherein the outer body is attachable to the aquarium by a clamp attached around the outer body.

9. The filter of claim 5, wherein the outer body is attachable to the aquarium by a mounting platform fixable to an aquarium floor and holding the outer tube to allow removal of the inner tube from the outer tube to replace filter media and rotation of the inner tube within the outer tub.

10. An aquarium filter comprising:
a cylindrical outer tube attachable to an aquarium;
a removable and rotatable smaller cylindrical inner tube residing inside the outer tube;
media residing inside the inner tube and replaceable by removing the inner tube from the outer tube;
a pump residing at a bottom end of the filter in fluid communication between the aquarium and the inner tube through adjustable inlet ports between the pump and inner tube;
transfer ports in the inner tube opposite the bottom end allowing a flow between the inner tube and the outer tube; and
outlet ports at the bottom of the outer tube allowing filtered water to be released into the aquarium.

11. An aquarium filter comprising:
a cylindrical outer tube attachable to an aquarium;
an outer tube base plug having outer tube inlet ports;
a removable and rotatable smaller cylindrical inner tube residing inside the outer tube;
media residing inside the inner tube and replaceable by removing the inner tube from the outer tube;
a pump residing at a bottom end of the filter in fluid communication between the aquarium and the inner tube;
transfer ports in the inner tube opposite the bottom end of the filter allowing a flow between the inner tube and the outer tube;
outlet ports at the bottom of the outer tube allowing filtered water to be released into the aquarium; and
the inner tube rotatable with respect to the outer tube and including an inner tube base plug having inner tube inlet ports, alignment of the inner tube inlet ports with the outer tube inlet ports adjustable by rotating the inner tube to control water flow through the aquarium filter.
